(19) United States
(12) Patent Application Publication
(10) Pub. No.: US 2019/0230408 A1
(43) Pub. Date: Jul. 25, 2019

(54) SYSTEM, METHOD, AND APPARATUS FOR TEMPORARY WIRELESS CONNECTION

(71) Applicant: QUALCOMM Incorporated, San Diego, CA (US)

(72) Inventors: Hooman BORGHEI, San Diego, CA (US); Shraddha Ramachandra PHADNIS, New Jersey, MA (US); Harini PADMANABAN, San Jose, CA (US)

(21) Appl. No.: 15/877,352

(22) Filed: Jan. 22, 2018

(51) Int. Cl. H04N 21/4363; H04L 29/08; G06Q 30/02; H04M 1/725; H04W 4/80; H04W 88/10

(52) U.S. Cl. CPC H04N 21/43637; H04L 67/02; G06Q 30/0267; H04W 88/10; H04M 1/72561; H04L 67/26; H04W 4/80; G06Q 30/0277

(57) ABSTRACT

In some examples of the disclosure, a secure temporary connection is established to share data, such as Uniform Resource Locator (“URL”) data, over a Bluetooth GATT and process the data without maintaining the connection. For instance, a temporary secure connection over a Bluetooth GATT may be used without having to transfer potentially personal information between the two devices, such as required in conventional approaches. In this example, a GATT connection is used to send the required information, and then the connection is closed before the information transferred is processed by the receiving device. Thus, a temporary BT GATT connection is established, and some data is transferred to a second BT enabled device such as a mobile device or headphones. The mobile device or headphones then goes and performs the action/processes the data without the need of a persistent BT connection.

### FIELD OF DISCLOSURE

This disclosure relates generally to wireless connections and more specifically, but not exclusively, to temporary wireless connections.

### BACKGROUND

Bluetooth Low Energy, aka BLE, aka Bluetooth Smart, is part of the Bluetooth v4.x specification. BLE was merged into the main Bluetooth standard in 2010 with the adoption of the Bluetooth Core Specification Version 4.0 and updated in Bluetooth 5 (both expressly incorporated herein in their entirety). BLE is not compatible with traditional Bluetooth. BLE is a low-power short-range communication protocol ideal for mobile and embedded devices. The low power aspect is achieved by having infrequent, small data packets with a maximum bit rate of about 30 KB/s. Thus, BLE is not recommended for high throughput applications such as video or audio streaming. It is common to see BLE applications that run on coin cell batteries for a year or more. BLE operates on the concept of a BLE stack that has many layers. Two of the topmost layers are the Generic Attribute Profile (“GATT”) and the Generic Access Profile (“GAP”). The GAP layer takes care of various control functions, such as security, connection management, and advertising are all part of the GAP layer. The GATT layer takes care of data exchange and data organization. The GATT layer uses the Attribute Protocol (ATT) as transport for data exchanges between devices.

BLE operates in two basic states: advertising and connected. If you look at the BLE specification, there are actually a bunch of sub-modes with special names for every case (broadcaster, initiator, advertiser, etc.), but in general all cases fall into these two states. In advertising mode the advertiser broadcasts data out to any scanner that is listening, sometimes with the intent to connect, sometimes with no intention of forming a connection. There is no guarantee of data being transferred; it is simply broadcast out for anyone to find. This is a one-to-many transfer. The advertising mode uses the GAP layer of the BLE stack. In connected mode two BLE devices are directly connected. In the connection a server serves data to a client. The terms ‘client’ and ‘server’ are used to express the directional flow of data, and as such both devices will be clients and servers during a two way flow of information. During a connected information transfer, data is guaranteed to be sent and is verified with a checksum. This is a one-to-one transfer. The connected mode uses the GATT layer of the BLE stack.

Therefore, BLE may be used as a communication protocol for establishing a wireless connection between two devices, such as a mobile phone and a wireless speaker. For example, a user with a mobile phone is visiting a location that has music playing on your Bluetooth/WiFi enabled speaker and wants to suggest a new song to share by playing the new song on the Bluetooth/WiFi speaker. Currently to do so it requires the user to pair the user's mobile device with the Bluetooth/WiFi speaker or connect to a local WiFi network (in case of WiFi speakers) using a WiFi password. Sharing WiFi password to just play temporary audio content may not be the best way as the WiFi network may have some secure systems connected to it (e.g., door security system). IN addition, pairing with the speaker over a Bluetooth connection requires a dedicated connection that during the play back of the song. What is needed is a solution that avoids having to share sensitive network access (e.g., sharing a WiFi password) or establish a long term dedicated connection.

Accordingly, there is a need for systems, apparatus, and methods that overcome the deficiencies of conventional approaches including the methods, system and apparatus provided hereby.

### SUMMARY

The following presents a simplified summary relating to one or more aspects and/or examples associated with the apparatus and methods disclosed herein. As such, the following summary should not be considered an extensive overview relating to all contemplated aspects and/or examples, nor should the following summary be regarded to identify key or critical elements relating to all contemplated aspects and/or examples or to delineate the scope associated with any particular aspect and/or example. Accordingly, the following summary has the sole purpose to present certain concepts relating to one or more aspects and/or examples relating to the apparatus and methods disclosed herein in a simplified form to precede the detailed description presented below.

In one aspect, a method includes: initializing a first Bluetooth (BT) device; initializing a second BT device; advertising, by the second BT device, capability information; scanning, by the first BT device, for an advertisement with the capability information; automatically initializing a GATT connection between the first BT device and the second BT device upon detection of the advertisement with the capability information by the first BT device; automatically sending, by the first BT device, temporary configuration parameters to the second BT device; automatically sending, by the first BT device, data to the second BT device; and disconnecting the GATT connection before the second BT device processes the data.

In another aspect, a non-transitory computer-readable medium comprises instructions that when executed by a processor cause the processor to perform a method comprising: initializing a first Bluetooth (BT) device; initializing a second BT device; advertising, by the second BT device, capability information; scanning, by the first BT device, for an advertisement with the capability information; automatically initializing a GATT connection between the first BT device and the second BT device upon detection of the advertisement with the capability information by the first BT device; automatically sending, by the first BT device, temporary configuration parameters to the second BT device; automatically sending, by the first BT device, data to the second BT device; and disconnecting the GATT connection before the second BT device processes the data.

In still another aspect, a first mobile device includes: a memory; a processor coupled to the memory; an antenna coupled to the processor; the processor configured to: initialize the first mobile device; scan, by the first BT device, for an advertisement with capability information; automatically initialize a GATT connection between the first mobile device and a second mobile device upon detection of the advertisement with the capability information by the first BT device, the second mobile device broadcasting the advertisement with the capability information; automatically send, by the first mobile device, temporary configuration parameters to the second mobile device; automatically send, by the first mobile device, data to the second mobile device; and disconnect the GATT connection before the second mobile device processes the data.

In still another aspect, a first mobile device includes: a memory; means for processing data coupled to the memory; means for communication coupled to the processor; the means for processing data configured to: initialize the first mobile device; scan, by the first mobile device, for an advertisement with capability information; automatically initialize a GATT connection between the first mobile device and a second mobile device upon detection of the advertisement with the capability information by the first mobile device, the second mobile device broadcasting the advertisement with the capability information; automatically send, by the first mobile device, temporary configuration parameters to the second mobile device; automatically send, by the first mobile device, data to the second mobile device; and disconnect the GATT connection before the second mobile device processes the data.

Other features and advantages associated with the apparatus and methods disclosed herein will be apparent to those skilled in the art based on the accompanying drawings and detailed description.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure, and in which:

FIG. 1 illustrates an exemplary first wireless device communicating with a second wireless device in accordance with some examples of the disclosure.

FIG. 2 illustrates an exemplary partial process flow for sending data from a first BT device to a second BT device in accordance with some examples of the disclosure.

FIG. 3 illustrates an exemplary partial process flow for sending data from a second BT device to a first BT device in accordance with some examples of the disclosure.

FIG. 4 illustrates a partial process for establishing a temporary BT connection between a first BT device and a second BT device in accordance with some examples of the disclosure.

FIG. 5 illustrates an exemplary mobile device in accordance with some examples of the disclosure.

FIG. 6 illustrates various electronic devices that may be integrated with any of the aforementioned integrated device, semiconductor device, integrated circuit, die, interposer, package or package-on-package (PoP) in accordance with some examples of the disclosure.

In accordance with common practice, the features depicted by the drawings may not be drawn to scale. Accordingly, the dimensions of the depicted features may be arbitrarily expanded or reduced for clarity. In accordance with common practice, some of the drawings are simplified for clarity. Thus, the drawings may not depict all components of a particular apparatus or method. Further, like reference numerals denote like features throughout the specification and figures.

### DETAILED DESCRIPTION

The exemplary methods, apparatus, and systems disclosed herein mitigate shortcomings of the conventional methods, apparatus, and systems, as well as other previously unidentified needs. Some examples of the disclosure overcome the disadvantages of conventional approaches by establishing a secure temporary connection to share the data, such as Uniform Resource Locator (“URL”) data including YouTube, Spotify, podcast URLs over a Bluetooth GATT and process the data without maintaining the connection. The solution can be extended to other use cases like connecting to a television in a restaurant to get the audio content URL, connect to a particular gate in airport to get flight updates, gym, vehicle BT connections, especially in a rental. In some examples of the disclosure, a temporary secure connection over a Bluetooth GATT is used without having to transfer potentially personal information between the two devices, such as required in conventional approaches. Instead, a GATT connection is used to send the required information, and then the connection is closed before the information transferred is processed by the receiving device. This avoids existing Bluetooth handshake mechanism while still providing a secure data transfer. For example, a temporary BT GATT connection is established, and some data is transferred to a second BT enabled device such as a mobile device or headphones. The mobile device or headphones then goes and preforms the action/processes the data without the need of a persistent BT connection.

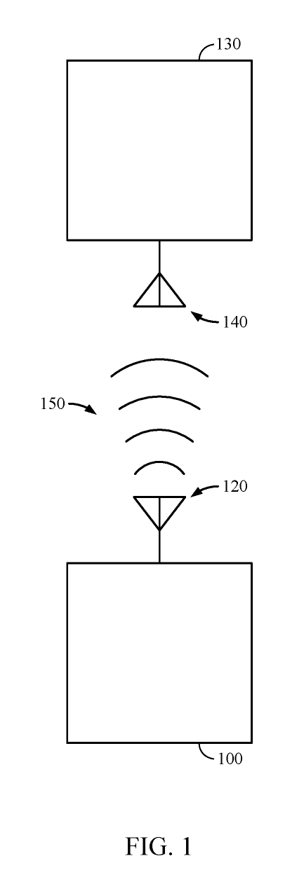

FIG. 1 illustrates an exemplary first wireless device communicating with a second wireless device in accordance with some examples of the disclosure. As shown in FIG. 1, a first wireless device 100 may include an antenna 120 integrated into or coupled to the first wireless device 100. The first wireless device 100 may be configured to periodically transmit advertising packets or scan for advertising packets wirelessly using a Bluetooth protocol and the antenna 120 over a medium 150, such as air, to a second wireless device 130. The second wireless device 130 may be a mobile device or a stationary device and may include an antenna 140 configured to receive the advertising packets transmitted by the first wireless device 100 or transmit advertising packets.

The first wireless device 100 may be configured to use a Bluetooth protocol for communication, such as Bluetooth Low Energy protocol. The first wireless device 100 may be configured to periodically transmit or scan for advertising packets at a first interval using antenna 120.

As mentioned above, the first wireless device 100 may be configured to use the Bluetooth Low Energy protocol and implement the BLE advertising service (see, for example, the Bluetooth specification 4.2). The BLE advertising is one of the most important aspects of Bluetooth Low Energy and may help lower the power consumption, speed up connections, and improve reliability. BLE has two ways of communicating. The first one is using advertisements, where a BLE enabled device broadcasts packets to every device around it. The receiving device can act on this information or connect to receive more information. The second way to communicate is to receive packets using a connection, where both the sending device and the connected device both send packets. A connection may be used to transmit information to another device only or establish a connection between two devices using advertisements. A BLE device sleeps most of the time, waking up only to advertise and connect when needed. This means advertisements have a big impact on power consumption. The advertising interval may be critical in conserving battery power and making quick connections. Advertising is by design unidirectional. A single BLE enable device may advertise to multiple devices in the area. BLE enabled devices may include a BLE Physical Layer. The BLE Physical Layer is in charge of actually sending the signals over the air. This includes the actual RF radio frequency (RF) antenna.

BLE shares some similarities with Classic Bluetooth. Both use the 2.4 GHz spectrum. Basic Rate (BR) and BLE both use Gaussian frequency shift keying (GFSK) modulation at 1 Mbps, but their modulation index is different. Enhanced Data Rate (EDR) uses a completely different modulation than GFSK. Classic Bluetooth has 79 channels compared to BLE's 40 channels. The channels are also spaced differently. Both of these differences make BLE and Classic Bluetooth different and incompatible, so they cannot communicate. The first wireless device 100 may also be configured with Dual Mode Radios that support both BLE and Classic Bluetooth by switching their modulation parameters and the channels on which the first wireless device 100 is running The 2.4 GHz spectrum for Classic Bluetooth extends from 2402 MHz to 2480 MHz while BLE uses 40 1 MHz wide channels, numbered 0 to 39. Each is separated by 2 MHz. Channels 37, 38, and 39 are typically used only for sending advertisement packets. The rest are used for data exchange during a connection.

During BLE advertisement, the first wireless device 100 or second wireless device 130 may transmit packets on the 3 advertising channels one after the other. The second wireless device 130 or the first wireless device 100 may scan for devices or beacons and listen to those channels for the advertising packets, which helps it discover devices nearby. Channels 37, 38 and 39 may be spread across the 2.4 GHz spectrum with channels 37 and 39 being the first and last channels in the band, while 38 is in the middle. If any single advertising channel is blocked, the other channels are likely to be free since they are separated by quite a few MHz of bandwidth. This is especially true since most other devices that interfere with BLE are narrow band. Channel 38 in particular was placed between Wi-Fi channels 1 and 6 so it avoids the Wi-Fi signal. The wide spacing of the advertisement channels helps BLE better manage the interference from Wi-Fi, Classic Bluetooth, Microwaves, Baby Monitors, etc. to ensure that advertisements succeed.

When the first wireless device 100 or the second wireless device 130 is in advertising mode, advertising packets may be sent periodically on each advertising channel. The time interval between packets may have both a fixed interval and a random delay. The first wireless device 100 or the second wireless device 130 may set the fixed interval from 20 milliseconds to 10.24 seconds, in steps of 0.625 milliseconds, for example. The random delay may be a pseudo-random value from 0 milliseconds to 10 milliseconds that is automatically added. This randomness helps reduce the possibility of collisions between advertisements of different devices. Since finding advertisements may be critical, avoiding collisions at all costs may be extremely important. Alternatively, the first wireless device 100 or the second wireless device 130 may be configured to advertise on just one or two channels, not all three to save power. The advertising interval may be separate from the connection interval to avoid interference.

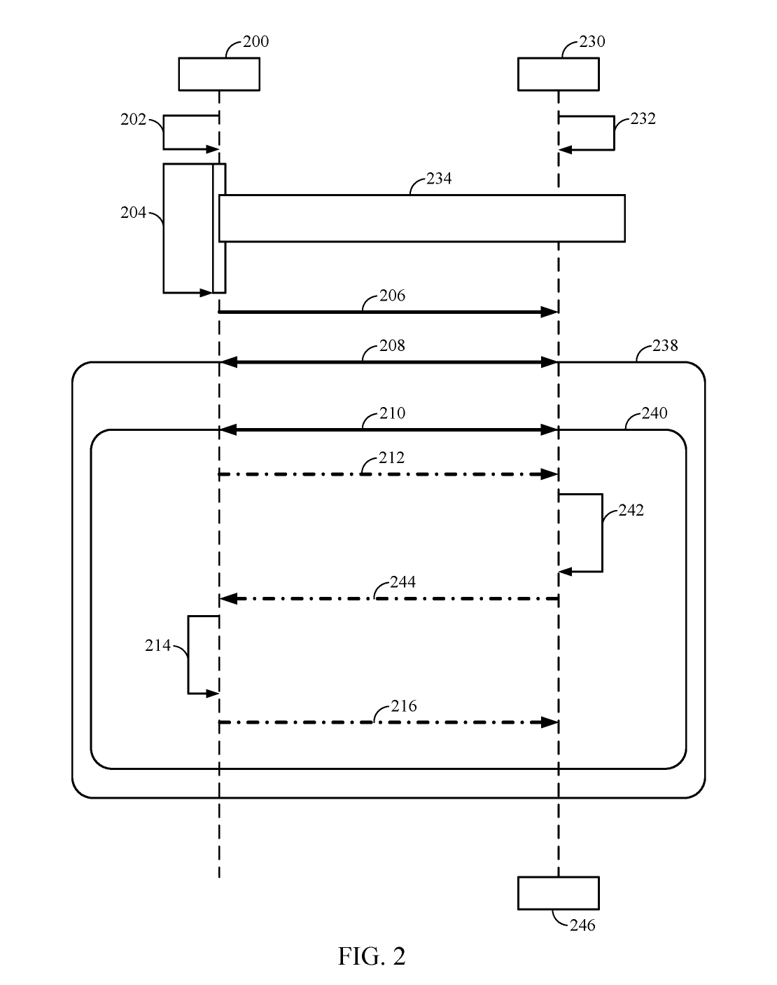

FIG. 2 illustrates an exemplary partial process flow for sending data from a first BT device to a second BT device in accordance with some examples of the disclosure, such as sending URL information from a mobile phone (first BT device) to a BT/WiFi speaker (second BT device). As shown in FIG. 2, a first BT device 200 may initialize 202 using conventional initializing parameters to configure the first BT device 200 to use a BT protocol, such as BLE. The initializing 202 of the first BT device 200 may also include configuring the first BT device 200 to automatically connect to another BT device (such as second BT device 230) that is advertising to establish a GATT connection for a temporary secure connection in accordance with examples herein. A second BT device 230 may also initialize 232 using conventional initializing parameters to configure the second BT device 230 to use a BT protocol, such as BLE. In one example, the first BT device 200 may be a mobile device and the second BT device may be a BT enabled speaker. After initialization, the second BT device 230 may transmit advertising packets 234 and the first BT device 200 may scan 204 for such advertising packets 234. The advertising packets 234 may include capability information, such as a special value, that indicates the second BT device 230 is capable of making a temporary secure GATT connection. When the scan 204 detects an advertising packet 234 with the capability information that indicates the second BT device 230 is available, the first BT device 200 may automatically initialize a GATT connection 206 between the first BT device 200 and the second BT device 230 upon detection of the advertising packets 234 and the capability information therein.

Subsequently, a GATT connection 208 is negotiated between the first BT device 200 and the second BT device 230 and, after successful negotiation (request and acceptance), a GATT connection is established 238 between the first BT device 200 and the second BT device 230. Next, the first BT device 200 and the second BT device 230 exchange secure connection configuration information 210 until a secure connection is established 240 between the first BT device 200 and the second BT device 230. Next, the first BT device 200 automatically (without a request from the second BT device 230) sends temporary configuration parameters 212 to the second BT device 230. The temporary configuration parameters 212 may include data, such as a URL or similar sized data compatible with BLE payloads and rates, as well as configuration information that instructs the second BT device 230 to wait to process the data until the GATT connection is disconnected. The second BT device 230 may then optionally send a response 244 to the first BT device 200 indicating success or failure. The first BT device 200 may then process 214 the response 244 by either resending the temporary configuration parameters 212 (such as if the response 244 indicates no reception by the second BT device 230), additional temporary configuration parameters 212 (such as when the data is too large for a single BLE payload), or disconnect 216 the GATT connection 238. It should be understood that the GATT connection may be terminated by either the first BT device 200 or the second BT device 230. After the GATT connection 238 is disconnected or no longer established, the second BT device 230 may process 246 the data received in the temporary configuration parameters 212 (such as access a URL indicated in the temporary configuration parameters 212 to play the indicated audio).

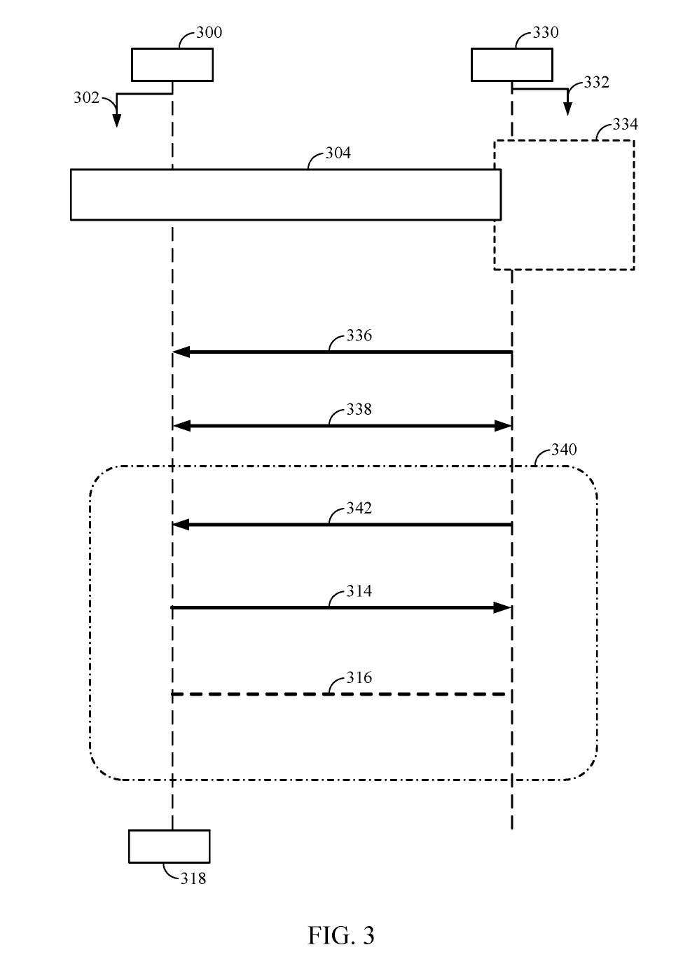

FIG. 3 illustrates an exemplary partial process flow for sending data from a second BT device to a first BT device in accordance with some examples of the disclosure. One example is a scenario where a mobile device (first BT device) user is in a restaurant with one or more televisions (second BT device). Typically, the one or more televisions do not broadcast the audio of the television program display to avoid disturbing the customers. If the mobile user would like to hear the audio, the mobile user may connect to the television of interest and request a link to the audio stream for local broadcasting. As shown in FIG. 3, a first BT device 300 may initialize 302 using conventional initializing parameters to configure the first BT device 300 to use a BT protocol, such as BLE. The initializing 302 of the first BT device 300 may also include configuring the first BT device 300 to automatically advertise 304 to another BT device (such as second BT device 330) to establish a GATT connection for a temporary secure connection in accordance with examples herein. A second BT device 330 may also initialize 332 using conventional initializing parameters to configure the second BT device 330 to use a BT protocol, such as BLE. In one example, the first BT device 300 may be a mobile device and the second BT device 330 may be a BT enabled television. After initialization, the first BT device 300 may transmit advertising packets 304 and the second BT device 330 may scan 334 for such advertising packets 204. The advertising packets 204 may include capability information, such as a special value, that indicates the second BT device 330 is capable of making a temporary secure GATT connection.. When the scan 334 detects an advertising packet 204 with the capability information that indicates the first BT device 300 is available, the second BT device 330 may automatically initialize a GATT connection 336 between the first BT device 300 and the second BT device 330 upon receipt of the advertising packets 304 and the capability information therein.

Subsequently, a GATT connection 338 is negotiated between the first BT device 300 and the second BT device 330 and, after successful negotiation (request and acceptance), a GATT connection is established 338 between the first BT device 300 and the second BT device 330. Next, the second BT device 330 automatically (without a request from the second BT device 230) sends temporary configuration parameters 342 to the first BT device 300. The temporary configuration parameters 342 may include data, such as a URL or similar sized data compatible with BLE payloads and rates, as well as configuration information that instructs the first BT device 300 to wait to process the data until the GATT connection is disconnected. The first BT device 300 may then optionally send a response 314 to the second BT device 330 indicating success or failure. The second BT device 330 may then process the response 314 by either resending the temporary configuration parameters 342 (such as if the response 314 indicates no reception by the first BT device 300), additional temporary configuration parameters 342 (such as when the data is too large for a single BLE payload), or disconnect 316 the GATT connection 338. After the GATT connection 338 is disconnected or no longer established, the first BT device 300 may process 318 the data received in the temporary configuration parameters 342 (such as access a URL indicated in the temporary configuration parameters 342).

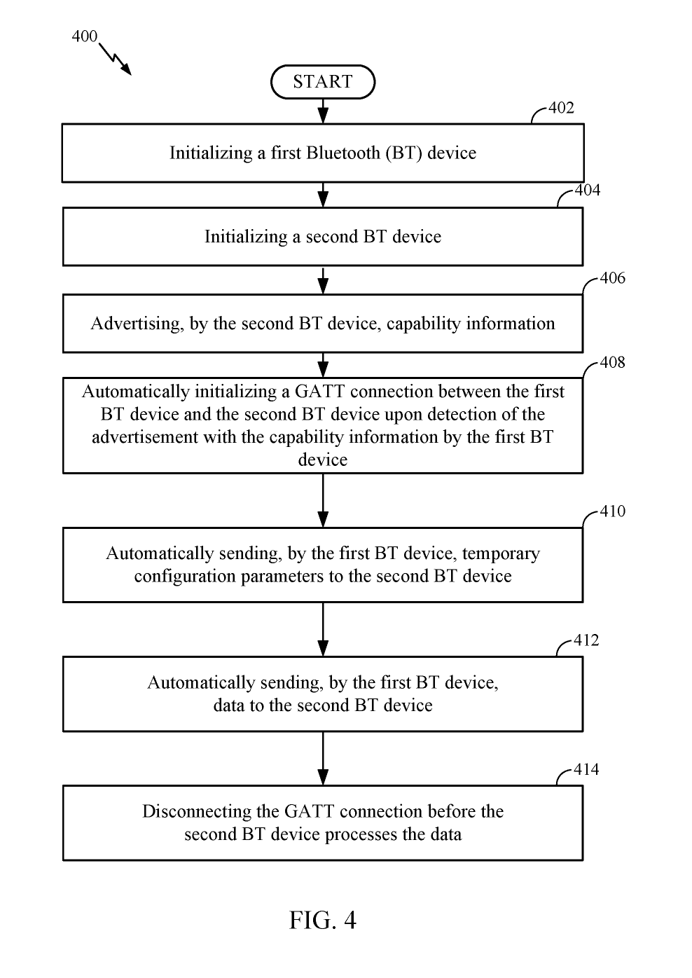

FIG. 4 illustrates a partial process for establishing a temporary BT connection between a first BT device and a second BT device in accordance with some examples of the disclosure. The partial process 400 begins in block 402 with initializing a first Bluetooth (BT) device (e.g., first wireless device 100, first BT device 200, or first BT device 300). The partial process 400 continues in block 404 with initializing a second BT device (e.g., second wireless device 130, second BT device 230, or second BT device 330). The partial process 400 continues in block 406 with advertising, by the second BT device, capability information. The partial process 400 continues in block 408 with automatically initializing a GATT connection between the first BT device and the second BT device upon detection of the advertisement with the capability information by the first BT device. The partial process 400 continues in block 410 with automatically sending, by the first BT device, temporary configuration parameters to the second BT device. The partial process 400 continues in block 412 with automatically sending, by the first BT device, data to the second BT device. The partial process 400 concludes in block 414 with disconnecting the GATT connection before the second BT device processes the data. In the partial process 400, the data may be a uniform resource locator, the GATT connection may be terminated prior to the second BT device accessing a resource indicated by the uniform resource locator, the first BT device and the second BT device may be Bluetooth Low Energy enabled devices, and the capability information and the temporary configuration parameters may be different. The partial process 400 may also include sending to the first BT device, by the second BT device, a write response prior to disconnecting the GATT connection, and configuring the second BT device based on the temporary configuration parameters.

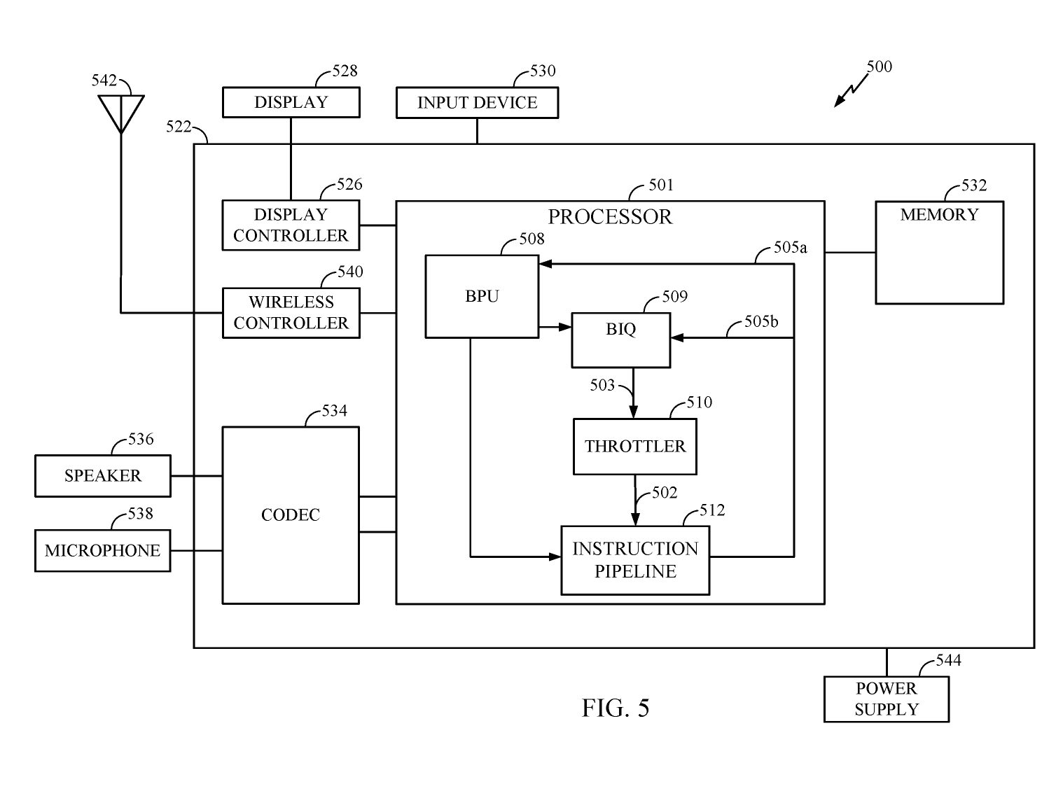

FIG. 5 illustrates an exemplary mobile device in accordance with some examples of the disclosure. Referring now to FIG. 5, a block diagram of a mobile device (e.g., first wireless device 100, second wireless device 130, first BT device 200, second BT device 230, first BT device 300, or second BT device 330) that is configured according to exemplary aspects is depicted and generally designated 500. In some aspects, mobile device 500 may be configured as a wireless communication device. As shown, mobile device 500 includes processor 501, which may be configured to implement the methods described herein in some aspects. Processor 501 is shown to comprise instruction pipeline 512, buffer processing unit (BPU) 508, branch instruction queue (BIQ) 509, and throttler 510 as is well known in the art. Other well-known details (e.g., counters, entries, confidence fields, weighted sum, comparator, etc.) of these blocks have been omitted from this view of processor 501 for the sake of clarity.

Processor 501 may be communicatively coupled to memory 532. Computing device 500 also include display 528 and display controller 526, with display controller 526 coupled to processor 501 and to display 528.

In some aspects, FIG. 5 may include coder/decoder (CODEC) 534 (e.g., an audio and/or voice CODEC) coupled to processor 501; speaker 536 and microphone 538 coupled to CODEC 534; and wireless controller 540 (which may include a modem) coupled to wireless antenna 542 and to processor 501.

In a particular aspect, where one or more of the above-mentioned blocks are present, processor 501, display controller 526, memory 532, CODEC 534, and wireless controller 540 can be included in a system-in-package or system-on-chip device 522. Input device 530 (e.g., physical or virtual keyboard), power supply 544 (e.g., battery), display 528, input device 530, speaker 536, microphone 538, wireless antenna 542, and power supply 544 may be external to system-on-chip device 522 and may be coupled to a component of system-on-chip device 522, such as an interface or a controller.

It should be noted that although FIG. 5 depicts a mobile device, processor 501 and memory 532 may also be integrated into a set top box, a music player, a video player, an entertainment unit, a navigation device, a personal digital assistant (PDA), a fixed location data unit, a computer, a laptop, a tablet, a communications device, a mobile phone, or other similar devices.

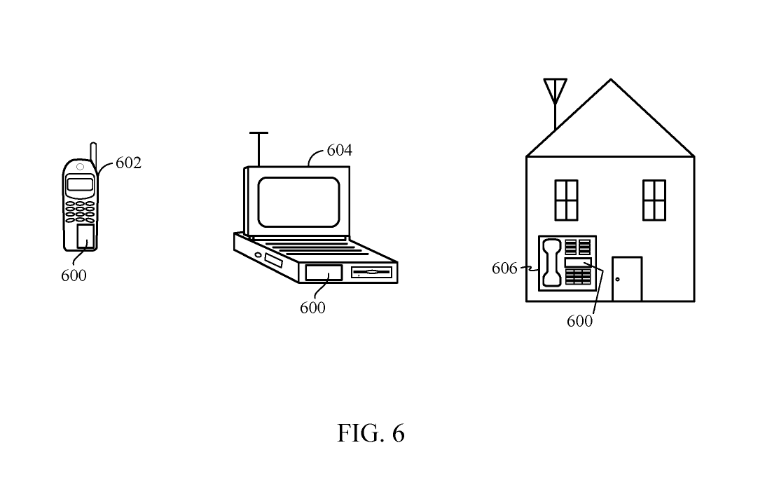

FIG. 6 illustrates various electronic devices that may be integrated with any of the aforementioned devices (e.g., first wireless device 100, second wireless device 130, first BT device 200, second BT device 230, first BT device 300, second BT device 330, or mobile device 500) in accordance with some examples of the disclosure. For example, a mobile phone device 602, a laptop computer device 604, and a fixed location terminal device 606 may include an integrated device 600 as described herein. The integrated device 600 may be, for example, any of the integrated circuits, dies, integrated devices, integrated device packages, integrated circuit devices, device packages, integrated circuit (IC) packages, package-on-package devices described herein. The devices 602, 604, 606 illustrated in FIG. 6 are merely exemplary. Other electronic devices may also feature the integrated device 600 including, but not limited to, a group of devices (e.g., electronic devices) that includes mobile devices, hand-held personal communication systems (PCS) units, portable data units such as personal digital assistants, global positioning system (GPS) enabled devices, navigation devices, set top boxes, music players, video players, entertainment units, fixed location data units such as meter reading equipment, communications devices, smartphones, tablet computers, computers, wearable devices, servers, routers, electronic devices implemented in automotive vehicles (e.g., autonomous vehicles), or any other device that stores or retrieves data or computer instructions, or any combination thereof.

It will be appreciated that various aspects disclosed herein can be described as functional equivalents to the structures, materials and/or devices described and/or recognized by those skilled in the art. For example, in one aspect, an apparatus may comprise a memory (e.g., memory 532), means for processing data (e.g., processor 501 or any of first wireless device 100, second wireless device 130, first BT device 200, second BT device 230, first BT device 300, second BT device 330, and mobile device 500)) coupled to the memory, means for communication (e.g., antenna 120, antenna 140, and antenna 542) coupled to the means for processing data wherein the means for processing data is configured to: initialize the first mobile device (e.g., first wireless device 100, first BT device 200, first BT device 300, or mobile device 500); scan, by the first mobile device, for an advertisement with capability information (e.g., advertisement packet 234 or advertise 304) ; automatically initialize a GATT connection between the first mobile device and the second mobile device upon detection of the advertisement with the capability information by the first mobile device, the second mobile device broadcasting the advertisement with the capability information; automatically send, by the first mobile device, temporary configuration parameters to the second mobile device; automatically send, by the first mobile device, data to the second mobile device; and disconnect the GATT connection before the second mobile device processes the data (e.g., partial process 400). It will be appreciated that the aforementioned aspects are merely provided as examples and the various aspects claimed are not limited to the specific references and/or illustrations cited as examples.

One or more of the components, processes, features, and/or functions illustrated in FIGS. 1-6 may be rearranged and/or combined into a single component, process, feature or function or incorporated in several components, processes, or functions. Additional elements, components, processes, and/or functions may also be added without departing from the disclosure. It should also be noted that FIGS. 1-6 and its corresponding description in the present disclosure is not limited to dies and/or ICs. In some implementations, FIGS. 1-6 and its corresponding description may be used to manufacture, create, provide, and/or produce integrated devices. In some implementations, a device may include a die, an integrated device, a die package, an integrated circuit (IC), a device package, an integrated circuit (IC) package, a wafer, a semiconductor device, a package on package (PoP) device, and/or an interposer.

In this description, certain terminology is used to describe certain features. The term “mobile device” can describe, and is not limited to, a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, an automotive device in an automotive vehicle, and/or other types of portable electronic devices typically carried by a person and/or having communication capabilities (e.g., wireless, cellular, infrared, short-range radio, etc.). Further, the terms “user equipment” (UE), “mobile terminal,” “mobile device,” and “wireless device,” can be interchangeable.

The wireless communication between electronic devices can be based on different technologies, such as code division multiple access (CDMA), W-CDMA, time division multiple access (TDMA), frequency division multiple access (FDMA), Orthogonal Frequency Division Multiplexing (OFDM), Global System for Mobile Communications (GSM), 3GPP Long Term Evolution (LTE), Bluetooth (BT), Bluetooth Low Energy (BLE) or other protocols that may be used in a wireless communications network or a data communications network. Bluetooth Low Energy (also known as Bluetooth LE, BLE, and Bluetooth Smart) is a wireless personal area network technology designed and marketed by the Bluetooth Special Interest Group intended to provide considerably reduced power consumption and cost while maintaining a similar communication range. BLE was merged into the main Bluetooth standard in 2010 with the adoption of the Bluetooth Core Specification Version 4.0 and updated in Bluetooth 5 (both expressly incorporated herein in their entirety).

The word “exemplary” is used herein to mean “serving as an example, instance, or illustration.” Any details described herein as “exemplary” is not to be construed as advantageous over other examples. Likewise, the term “examples” does not mean that all examples include the discussed feature, advantage or mode of operation. Furthermore, a particular feature and/or structure can be combined with one or more other features and/or structures. Moreover, at least a portion of the apparatus described hereby can be configured to perform at least a portion of a method described hereby.

The terminology used herein is for the purpose of describing particular examples and is not intended to be limiting of examples of the disclosure. As used herein, the singular forms “a,” “an,” and “the” are intended to include the plural forms as well, unless the context clearly indicates otherwise. It will be further understood that the terms “comprises”, “comprising,” “includes,” and/or “including,” when used herein, specify the presence of stated features, integers, actions, operations, elements, and/or components, but do not preclude the presence or addition of one or more other features, integers, actions, operations, elements, components, and/or groups thereof.

It should be noted that the terms “connected,” “coupled,” or any variant thereof, mean any connection or coupling, either direct or indirect, between elements, and can encompass a presence of an intermediate element between two elements that are “connected” or “coupled” together via the intermediate element.

Any reference herein to an element using a designation such as “first,” “second,” and so forth does not limit the quantity and/or order of those elements. Rather, these designations are used as a convenient method of distinguishing between two or more elements and/or instances of an element. Also, unless stated otherwise, a set of elements can comprise one or more elements.

Further, many examples are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be incorporated entirely within any form of computer readable storage medium having stored therein a corresponding set of computer instructions that upon execution would cause an associated processor to perform the functionality described herein. Thus, the various aspects of the disclosure may be incorporated in a number of different forms, all of which have been contemplated to be within the scope of the claimed subject matter. In addition, for each of the examples described herein, the corresponding form of any such examples may be described herein as, for example, “logic configured to” perform the described action.

Nothing stated or illustrated depicted in this application is intended to dedicate any component, action, feature, benefit, advantage, or equivalent to the public, regardless of whether the component, action, feature, benefit, advantage, or the equivalent is recited in the claims.

Further, those of skill in the art will appreciate that the various illustrative logical blocks, modules, circuits, and algorithm actions described in connection with the examples disclosed herein may be implemented as electronic hardware, computer software, or combinations of both. To clearly illustrate this interchangeability of hardware and software, various illustrative components, blocks, modules, circuits, and actions have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The methods, sequences and/or algorithms described in connection with the examples disclosed herein may be incorporated directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art including non-transitory types of memory or storage mediums. An exemplary storage medium is coupled to the processor such that the processor can read information from, and write information to, the storage medium. In the alternative, the storage medium may be integral to the processor.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

Although some aspects have been described in connection with a device, it goes without saying that these aspects also constitute a description of the corresponding method, and so a block or a component of a device should also be understood as a corresponding method action or as a feature of a method action. Analogously thereto, aspects described in connection with or as a method action also constitute a description of a corresponding block or detail or feature of a corresponding device. Some or all of the method actions can be performed by a hardware apparatus (or using a hardware apparatus), such as, for example, a microprocessor, a programmable computer or an electronic circuit. In some examples, some or a plurality of the most important method actions can be performed by such an apparatus.

In the detailed description above it can be seen that different features are grouped together in examples. This manner of disclosure should not be understood as an intention that the claimed examples have more features than are explicitly mentioned in the respective claim. Rather, the disclosure may include fewer than all features of an individual example disclosed. Therefore, the following claims should hereby be deemed to be incorporated in the description, wherein each claim by itself can stand as a separate example. Although each claim by itself can stand as a separate example, it should be noted that-although a dependent claim can refer in the claims to a specific combination with one or a plurality of claims-other examples can also encompass or include a combination of said dependent claim with the subject matter of any other dependent claim or a combination of any feature with other dependent and independent claims. Such combinations are proposed herein, unless it is explicitly expressed that a specific combination is not intended. Furthermore, it is also intended that features of a claim can be included in any other independent claim, even if said claim is not directly dependent on the independent claim.

It should furthermore be noted that methods, systems, and apparatus disclosed in the description or in the claims can be implemented by a device comprising means for performing the respective actions of this method.

Furthermore, in some examples, an individual action can be subdivided into a plurality of sub-actions or contain a plurality of sub-actions. Such sub-actions can be contained in the disclosure of the individual action and be part of the disclosure of the individual action.

While the foregoing disclosure shows illustrative examples of the disclosure, it should be noted that various changes and modifications could be made herein without departing from the scope of the disclosure as defined by the appended claims. The functions and/or actions of the method claims in accordance with the examples of the disclosure described herein need not be performed in any particular order. Additionally, well-known elements will not be described in detail or may be omitted so as to not obscure the relevant details of the aspects and examples disclosed herein. Furthermore, although elements of the disclosure may be described or claimed in the singular, the plural is contemplated unless limitation to the singular is explicitly stated.

What is claimed is:

1. A method for making a temporary Generic Attribute Profile (GATT) connection, comprising:
initializing a first Bluetooth (BT) device;
initializing a second BT device;
advertising, by the second BT device, capability information;
scanning, by the first BT device, for an advertisement with the capability information;
automatically initializing a GATT connection between the first BT device and the second BT device upon detection of the advertisement with the capability information by the first BT device;
automatically sending, by the first BT device, temporary configuration parameters to the second BT device;
automatically sending, by the first BT device, data to the second BT device; and
disconnecting the GATT connection before the second BT device processes the data.

2. The method of claim 1, wherein the data is a uniform resource locator.

3. The method of claim 2, wherein the GATT connection is terminated prior to the second BT device accessing a resource indicated by the uniform resource locator.

4. The method of claim 1, wherein the first BT device and the second BT device are Bluetooth Low Energy enabled devices.

5. The method of claim 1, wherein the capability information and the temporary configuration parameters are different.

6. The method of claim 1, further comprising sending to the first BT device, by the second BT device, a write response prior to disconnecting the GATT connection.

7. The method of claim 1, further comprising configuring the second BT device based on the temporary configuration parameters.

8. The method of claim 1, wherein the first BT device is incorporated into a device selected from the group consisting of a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, and a device in an automotive vehicle.

9. A non-transitory computer-readable medium comprising instructions that when executed by a processor cause the processor to perform a method comprising:
initializing a first Bluetooth (BT) device;
initializing a second BT device;
advertising, by the second BT device, capability information;
scanning, by the first BT device, for an advertisement with the capability information;
automatically initializing a GATT connection between the first BT device and the second BT device upon detection of the advertisement with the capability information by the first BT device;
automatically sending, by the first BT device, temporary configuration parameters to the second BT device;
automatically sending, by the first BT device, data to the second BT device; and
disconnecting the GATT connection before the second BT device processes the data.

10. The non-transitory computer-readable medium of claim 9, wherein the data is a uniform resource locator.

11. The non-transitory computer-readable medium of claim 10, wherein the GATT connection is terminated prior to the second BT device accessing a resource indicated by the uniform resource locator.

12. The non-transitory computer-readable medium of claim 9, wherein the first BT device and the second BT device are Bluetooth Low Energy enabled devices.

13. The non-transitory computer-readable medium of claim 9, wherein the capability information and the temporary configuration parameters are different.

14. The non-transitory computer-readable medium of claim 9, wherein the method further comprises sending to the first BT device, by the second BT device, a write response prior to disconnecting the GATT connection.

15. The non-transitory computer-readable medium of claim 9, wherein the method further comprises configuring the second BT device based on the temporary configuration parameters.

16. The non-transitory computer-readable medium of claim 9, wherein the first BT device is incorporated into a device selected from the group consisting of a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, and a device in an automotive vehicle.

17. A first mobile device comprising:
a memory;
a processor coupled to the memory;
an antenna coupled to the processor;
the processor configured to:
initialize the first mobile device;
scan, by the first mobile device, for an advertisement with capability information;
automatically initialize a GATT connection between the first mobile device and a second mobile device upon detection of the advertisement with the capability information by the first mobile device, the second mobile device broadcasting the advertisement with the capability information;
automatically send, by the first mobile device, temporary configuration parameters to the second mobile device;
automatically send, by the first mobile device, data to the second mobile device; and
disconnect the GATT connection before the second mobile device processes the data.

18. The first mobile device of claim 17, wherein the data is a uniform resource locator.

19. The first mobile device of claim 18, wherein the GATT connection is terminated prior to the second mobile device accessing a resource indicated by the uniform resource locator.

20. The first mobile device of claim 17, wherein the first mobile device and the second mobile device are Bluetooth Low Energy enabled devices.

21. The first mobile device of claim 17, wherein the capability information and the temporary configuration parameters are different.

22. The first mobile device of claim 17, wherein the processor is further configured to receive by the first mobile device a write response from the second mobile device prior to disconnecting the GATT connection.

23. The first mobile device of claim 17, wherein the second mobile device is configured based on the temporary configuration parameters.

24. The first mobile device of claim 17, wherein the first mobile device is incorporated into a device selected from the group consisting of a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, and a device in an automotive vehicle.

25. A first mobile device comprising:
a memory;
means for processing data coupled to the memory;
means for communication coupled to the processor;
the means for processing data configured to:
initialize the first mobile device;
scan, by the first mobile device, for an advertisement with capability information;
automatically initialize a GATT connection between the first mobile device and a second mobile device upon detection of the advertisement with the capability information by the first mobile device, the second mobile device broadcasting the advertisement with the capability information;
automatically send, by the first mobile device, temporary configuration parameters to the second mobile device;
automatically send, by the first mobile device, data to the second mobile device; and
disconnect the GATT connection before the second mobile device processes the data.

26. The first mobile device of claim 25, wherein the data is a uniform resource locator.

27. The first mobile device of claim 26, wherein the GATT connection is terminated prior to the second mobile device accessing a resource indicated by the uniform resource locator.

28. The first mobile device of claim 25, wherein the capability information and the temporary configuration parameters are different.

29. The first mobile device of claim 25, wherein the means for processing data is further configured to receive by the first mobile device a write response from the second mobile device prior to disconnecting the GATT connection.

30. The first mobile device of claim 25, wherein the second mobile device is configured based on the temporary configuration parameters.
